(19) United States
(12) Patent Application Publication
(10) Pub. No.: US 2008/0134283 A1
(43) Pub. Date: Jun. 5, 2008

(54) Security apparatus and method for supporting IPv4 and IPv6

(75) Inventors: Sang Gil Park, Daejeon-city (KR); Jintae Oh, Daejeon-city (KR); Taek Yong Nam, Daejeon-city (KR)

Correspondence Address: BLAKELY SOKOLOFF TAYLOR & ZAFMAN, 1279 OAKMEAD PARKWAY, SUNNYVALE, CA, 94085-4040, US

(73) Assignee: Electronics and Telecommunications Research Institute

(21) Appl. No.: 11/899,236

(22) Filed: Sep. 4, 2007

(30) Foreign Application Priority Data
Dec. 5, 2006 (KR) 10- 2006-0122659
May 30, 2007 (KR) 10- 2007-0052931

(51) Int. Cl. G06F 21/00

(52) U.S. Cl. 726/1

(57) ABSTRACT

Provided is a security method and apparatus for supporting IPv4 and IPv6. The security apparatus includes a packet classifier classifying an IPv4 packet and an IPv6 packet based on version information in header information of an input IP packet, a key generator generating header information corresponding to each of the classified IPv4 and IPv6 packets and generating a discrimination key corresponding to each of the classified IPv4 and IPv6 packets based on the generated header information, and a lookup engine comprising a first bank in which a security policy for IPv4 packets is established and a second bank in which a security policy for IPv6 packets is established, by which the first bank and the second bank are searched using the discrimination key corresponding to each packet.

### CROSS-REFERENCE TO RELATED PATENT APPLICATION

This application claims the benefit of Korean Patent Application No. 10-2006-0122659, filed on Dec. 5, 2006 and Korean Patent Application No. 10-2007-0052931, filed on May 30, 2007 in the Korean Intellectual Property Office, the disclosures of which are incorporated herein in their entirety by reference.

### BACKGROUND OF THE INVENTION

1. Field of the Invention

The present invention relates to a security apparatus and method for supporting Internet Protocol version 4 (IPv4) and IPv6.

2. Description of the Related Art

Network devices, such as routers and switches, operating a network packet use a Contents Addressable Memory (CAM) or Ternary CAM (TCAM) in order to distinguish packets from each other. Since the TCAM or CAM is expensive, low-speed systems provide packet discrimination using a software algorithm.

General network security devices separately provide a TCAM for Internet Protocol version 4 (IPv4) and a TCAM for IPv6 in order to provide a dual-stack security apparatus for processing IPv4 and IPv6. This is because it is difficult to provide IPv4 and IPv6 using a single TCAM.

In the case of IPv4, each packet is discriminated using a 32-bit source IP address, a 32-bit destination IP address, a 16-bit source port, a 16-bit destination port, an 8-bit protocol, an 8-bit Internet Control Message Protocol (ICMP) type, an 8-bit ICMP code, and information on a field (e.g., a Transmission Control Protocol (TCP) flag) for discriminating a packet in the contents of a packet header. On the other hand, in the case of IPv6, each IP address extends to 128 bits from 32 bits of IPv4.

In order to discriminate each packet using all information of IPv6, a structure for processing more than 300-bit information including 128-bit source/destination IP addresses (total 256 bits), 16-bit source/destination ports (total 32 bits), an 8-bit protocol, 8-bit ICMP type/code (total 16 bits), and other information must be provided. In particular, when a method of hashing information is used in order to provide a ternary function, a wrong policy may be applied not by smoothly supporting masking.

Although a product providing a security function by applying a packet filtering function and a bandwidth control function to IPv4 has been available on the market, technology of responding against intrusions, which has been used in IPv4, is difficult to be used in IPv6 due to limitations on a packet length and an address length.

In addition, since technologies providing a security function to IPv6 use a plurality of TCAMs, it is difficult to actually implement the technologies due to a cost increase.

### SUMMARY OF THE INVENTION

The present invention provides a network attack security apparatus implemented by hardware, whereby a unit cost is decreased by physically using a single lookup device and both IPv4 and IPv6 are supported.

According to an aspect of the present invention, there is provided a security apparatus for supporting Internet Protocol version 4 (IPv4) and IPv6, the apparatus comprising: a packet classifier classifying an IPv4 packet and an IPv6 packet based on version information in header information of an input IP packet; a key generator generating header information corresponding to each of the classified IPv4 and IPv6 packets and generating a discrimination key corresponding to each of the classified IPv4 and IPv6 packets based on the generated header information; and a lookup engine comprising a first bank in which a security policy for IPv4 packets is established and a second bank in which a security policy for IPv6 packets is established, by which the first bank and the second bank are searched using the discrimination key corresponding to each packet.

A different number of bits may be assigned to the first bank and the second bank.

The discrimination key corresponding to the IPv6 packet may be generated using a hashing function, and the second bank establishes the security policy using the hashing function

According to another aspect of the present invention, there is provided a security method in a security apparatus for supporting Internet Protocol version 4 (IPv4) and IPv6, the method comprising: classifying an IPv4 packet and an IPv6 packet based on version information in header information of an input IP packet; generating header information corresponding to each of the classified IPv4 and IPv6 packets and generating a discrimination key corresponding to each of the classified IPv4 and IPv6 packets based on the generated header information; and searching a lookup engine, which comprises a first bank in which a security policy for IPv4 packets is established and a second bank in which a security policy for IPv6 packets is established, as the first bank and the second bank using the discrimination key corresponding to each packet.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a network attack security device;

FIG. 2 is a block diagram of a security apparatus for supporting IPv4 and IPv6 according to an embodiment of the present invention;

FIG. 3 illustrates a discrimination key generated in a case of IPv4;

FIG. 4 illustrates a discrimination key generated in a case of IPv6;

FIG. 5 illustrates the use of banks in a lookup engine according to an embodiment of the present invention; and

FIG. 6 is a flowchart of a process of processing a packet according to an internal security policy in a security apparatus according to an embodiment of the present invention.

### DETAILED DESCRIPTION OF THE INVENTION

The present invention will be described in detail by explaining preferred embodiments of the invention with reference to the attached drawings. Like reference numerals in the drawings denote like elements. In the following description, well-known functions or constructions are not described in detail since they would obscure the invention with unnecessary detail.

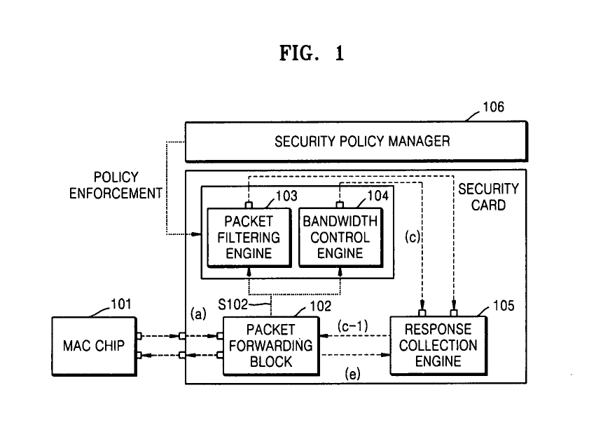

FIG. 1 is a block diagram of a network attack security device.

FIG. 1 illustrates a Gigabit-based network attack security device detecting a packet attack misused and abused in a network and performing an attack response function by means of packet filtering or bandwidth control with respect to a packet input through a Gigabit Ethernet interface.

A packet is input to a security card of a hardware appliance via a Media Access Control (MAC) chip 101. A Layer 3 (L3) Internet Protocol (IP) packet is extracted from this input L2 packet by a packet forwarding block 102. The extracted L3 IP packet is transmitted to a packet filtering engine 103 and a bandwidth control engine 104 via an interface S102. The packet filtering engine 103 and the bandwidth control engine 104 generate information on whether the L3 IP packet corresponds to an IPv4 or IPv6 packet by parsing the L3 IP packet received via the interface S102 and perform a parsing flow according to an IP version.

By each parsing flow, source and destination address information, port information, and other field information are acquired. In order to determine using the generated packet information whether the packet meets a rule, a Ternary Contents Addressable Memory (TCAM) is inquired by generating 8-bit discrimination key information.

The 8-bit discrimination key information is as follows:

0: Rule valid

1: IP version (0: IPv4, 1: IPv6)

2: Function (0: Logic 1 (103), 1: Logic 2 (104)

3: Logic (0: Logic A (network connected to PM3386(0)), 1: Logic B (network connected to PM3386(1)))

4: Port (direction information (0: 0→1), (1: 1→0))

5˜7: Protocol value for IPv6 (1: ICMPv6, 2: User Datagram Protocol (UDP), 6: TCP), NULL value for IPv4.

A TCAM interface used in the present invention is formed in a pipeline type for providing IPv4/IPv6 version information and 144-bit lookup/288-bit lookup performing information. The rule can be inquired by performing one TCAM inquiry using the TCAM interface.

When at least two TCAMs are used for an IPv6 packet, a result of each TCAM is collected, and if both results are ‘1’, it is determined that the IPv6 packet meets the rule. Rather than this method of storing these results and generating a final result, using one TCAM inquiry, both an IPv4 packet and an IPv6 packet can be processed.

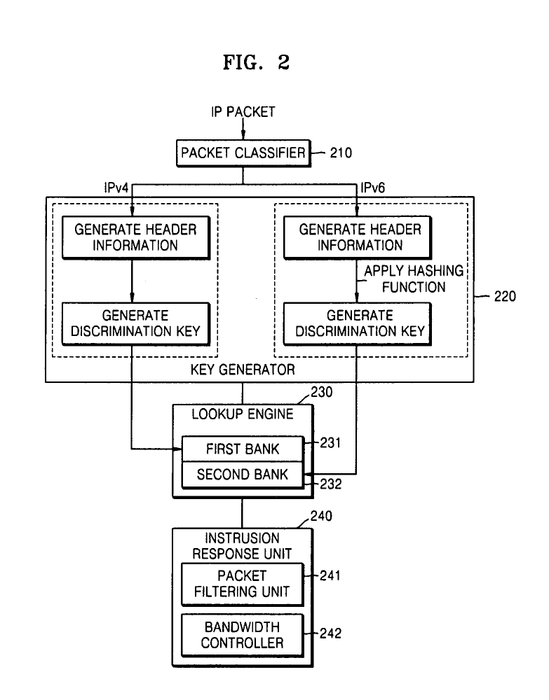

FIG. 2 is a block diagram of a security apparatus for supporting IPv4 and IPv6 according to an embodiment of the present invention.

Referring to FIG. 2 the security apparatus includes a packet classifier 210, a key generator 220, a lookup engine 230, and an intrusion response unit 240.

The packet classifier 210 classifies an IPv4 packet and an IPv6 packet based on version information in header information of an input IP packet.

The key generator 220 generates header information corresponding to the IPv4 packet or the IPv6 packet classified by the packet classifier 210 and generates a discrimination key corresponding to the IPv4 packet or the IPv6 packet based on the generated header information.

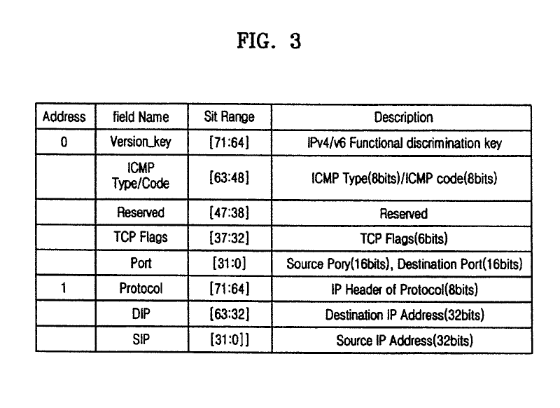

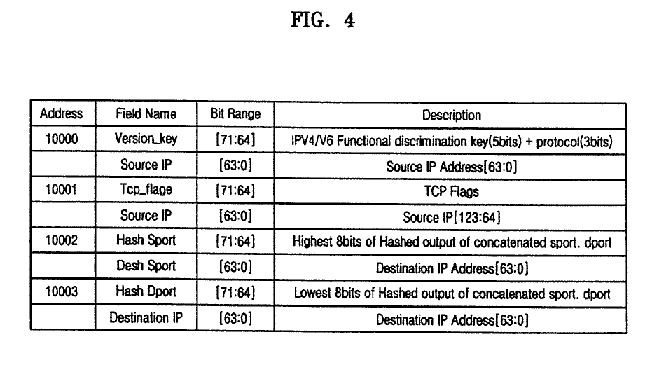

That is, basic packet header information is generated from the IP packet classified by the packet classifier 210 by operating an IPv4 parsing module for the IPv4 packet or operating an IPv6 parsing module for the IPv6 packet according to an IP version. The discrimination key for inquiring the lookup engine 230 is generated based on the five generated packet information (source address, destination address, source port, destination port, and protocol) and additional information such as a TCP flag, an ICMP type, and an ICMP code (refer to FIGS. 3 and 4).

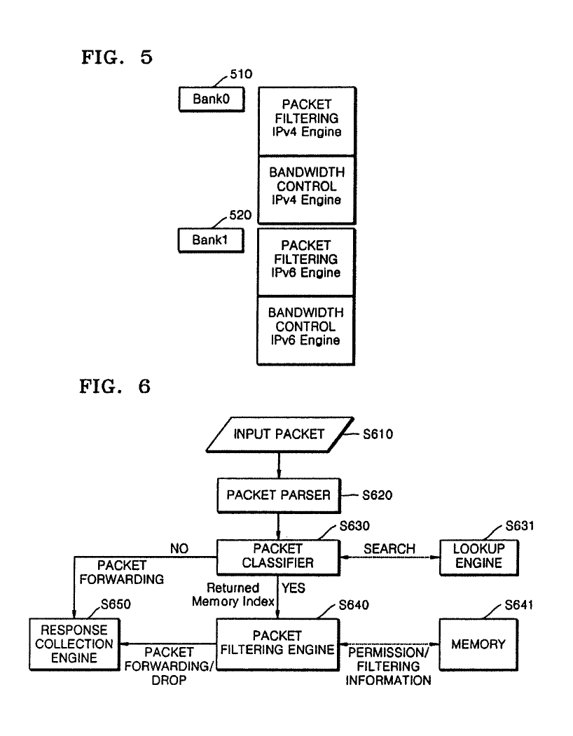

The lookup engine 230 includes two banks 231 and 232 (refer to FIG. 5). Different bits are assigned to the two banks 231 and 232. An IPv4 security policy and an IPv6 security policy are recorded in the lookup engine 230. In this way, both an IPv4 packet and an IPv6 packet can be searched in the current embodiment by physically using a single lookup engine.

The intrusion response unit 240 includes a packet filtering unit 241 and a bandwidth controller 242.

For example, 144 bits are assigned to the first bank 231 in which the security policy for an IPv4 packet is established, and accordingly, a 144-bit search mode can be performed. In addition, 288 bits are assigned to the second bank 232 in which the security policy for an IPv6 packet is established, and accordingly, a 288-bit search mode can be performed. Thus, each bank can apply a different search method.

The packet filtering unit 241 decides a lookup key, which is a key value corresponding to the security policy established in the first bank 231 or the second bank 232, and if the lookup key matches the discrimination key generated according to the IPv4 packet or the IPv6 packet by the key generator 220, the packet filtering unit 241 discards or transmits the packet according to the security policy.

The bandwidth controller 242 decides a lookup key, which is a key value corresponding to the security policy established in the first bank 231 or the second bank 232, and if the lookup key matches the discrimination key, the bandwidth controller 242 controls a bandwidth according to the security policy.

FIG. 3 illustrates a discrimination key generated in a case of IPv4.

In the present invention, in the case of IPv4, the length of a key used in a lookup engine can be up to 144 bits. In order to use the key, if 72 bits are physically set as a single address value, two addresses, such as an address0 and an address1, are used, and a bank0 is used.

In the address0, a source port (16 bits), a destination port (16 bits), TCP flag information (6 bits), an ICMP type (8 bits), an ICMP code (8 bits), and an 8-bit discrimination key set for IPv4/IPv6 discrimination, function discrimination, and logic discrimination in an entire lookup engine are used.

In software in which a security rule is applied to hardware, the security rule is also recorded in a lookup engine using the system illustrated in FIG. 3, and even when an IPv4 packet is input to a hardware chipset, the software is configured to generate a key value as illustrated in FIG. 3 based on parsed field information of the input IPv4 packet.

When a lookup engine is inquired using the key value, if a rule exists in the lookup engine, information, such as ‘lookup rule inquiry valid (SSV)’ and ‘lookup rule success (SSF)’, is generated. Engines, such as the packet filtering engine 103 and the bandwidth control engine 104, providing security functions provide security functions, such as packet filtering and bandwidth control, using the generated values.

FIG. 4 illustrates a discrimination key generated in a case of IPv6.

In the present invention, in the case of IPv6, the length of a key used in a lookup engine can be up to 288 bits. In order to use the key, if 72 bits are physically set as a single address value, four addresses, such as an address0, an address1, an address2, and an address3, are used, and a bank1 is used.

A discrimination key containing IP version information and lower 64 bits of a 144-bit source address are recorded in the address0. A TCP flag value and higher 64 bits of the 144-bit source address are recorded in the address1. An 8-bit value obtained by hashing a source port and lower 64 bits of a 144-bit destination address are recorded in the address2.

In the case of an ICMP packet, the 8-bit value obtained by hashing the source port is replaced with an ICMP type. An 8-bit value obtained by hashing a destination port and higher 64 bits of the 144-bit destination address are recorded in the address3. In the case of an ICMP packet, the 8-bit value obtained by hashing the destination port is replaced with an ICMP code.

In software in which a security rule corresponding to an IPv6 packet is applied to hardware, the security rule is also recorded in a lookup engine using the system illustrated in FIG. 4, and even when an IPv4 packet is input to a hardware chipset, the software is configured to generate a key value as illustrated in FIG. 4 based on parsed field information of the input IPv6 packet.

When a lookup engine is inquired using the key value, if a rule exists in the lookup engine, information, such as ‘lookup rule success (SSF)’, is generated. Engines, such as the packet filtering engine 103 and the bandwidth control engine 104, providing security functions provide security functions, such as packet filtering and bandwidth control, using the generated values.

FIG. 5 illustrates the use of banks in a lookup engine according to an embodiment of the present invention.

Referring to FIG. 5, a security policy for an IPv4 packet is established in a bank0 510, and a security policy for an IPv6 packet is established in a bank1 520. Since software recording and managing a security rule provides two security functions (packet filtering and bandwidth control) using a single physical lookup engine and is applied to IPv4 and IPv6, the lookup engine is logically divided into four address regions.

FIG. 6 is a flowchart of a process of processing a packet according to an internal security policy in a security apparatus according to an embodiment of the present invention.

After an L2 packet is input via the MAC chip (101 of FIG. 1) and an L3 packet (IP packet) is extracted by the packet filtering engine (103 of FIG. 1), a packet is input in operation S610. An IPv4 packet parser or an IPv6 packet parser operates according to an IP version of the input packet in operation S620.

A key value as illustrated in FIG. 3 (in the case of IPv4) or a key value as illustrated in FIG. 4 (in the case of IPv6) is generated using 5-tuple (source address, destination address, source port, destination port, and protocol) of the packet generated by the packet parser.

A physical lookup engine S631 is inquired in a 144-bit unit (in the case of IPv4) or in a 288-bit unit (in the case of IPv6) using the generated key value. The lookup engine S631 generates an information signal described below in order to inform whether an inquired result matches a rule previously recorded by software.

A lookup rule inquiry valid (SSV) signal is a signal for determining lookup engine success/failure in a state where the lookup rule inquiry valid (SSV) signal is valid by the lookup engine. In the state where the lookup rule inquiry valid (SSV) signal is valid, the lookup engine generates a lookup rule success (SSF) signal. The lookup engine generates ‘1’ if the inquiry succeeds or ‘0’ if the inquiry fails.

An internal packet classifier S630 reflects a result of the lookup engine S631 to the packet filtering engine (103 of FIG. 1) and the bandwidth control engine (104 of FIG. 1) using the result value of the lookup engine S631. If the inquiry of the lookup engine S631 succeeds, the packet classifier S630 transmits the lookup rule inquiry valid (SSV) signal and a corresponding memory index address.

The packet filtering engine (103 of FIG. 1) and the bandwidth control engine (104 of FIG. 1) perform security functions based on the memory index and transmit a result (packet transmission or discard) to a response collection engine (RCSB) S650. The response collection engine S650 transmits or discards the packet according to the result.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

As described above, according to the present invention, in order to control traffic as a countermeasure of harmful traffic or on the purpose of Quality of Service (QoS) in a dual stack system supporting both IPv4 and IPv6, a hardware construction method and a mechanism are suggested.

Although the present invention is implemented using hardware, a manager can set the hardware using a device driver, and the hardware can be applied to a 10/100 Ethernet environment, a Gigabit environment, and PoS using the set value.

When this dual stack scheme and a permission/filtering rule are applied, permission/filtering can be applied to an IPv4 packet and an IPv6 packet by physically using a single chipset.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A security apparatus for supporting Internet Protocol version 4 (IPv4) and IPv6, the apparatus comprising:
a packet classifier classifying an IPv4 packet and an IPv6 packet based on version information in header information of an input IP packet;
a key generator generating header information corresponding to each of the classified IPv4 and IPv6 packets and generating a discrimination key corresponding to each of the classified IPv4 and IPv6 packets based on the generated header information; and
a lookup engine comprising a first bank in which a security policy for IPv4 packets is established and a second bank in which a security policy for IPv6 packets is established, by which the first bank and the second bank are searched using the discrimination key corresponding to each packet.

2. The apparatus of claim 1, wherein the discrimination key corresponding to the IPv6 packet is generated using a hashing function.

3. The apparatus of claim 2, wherein the second bank establishes the security policy using the hashing function.

4. The apparatus of claim 1, wherein a different number of bits are assigned to each of the first bank and the second bank.

5. The apparatus of claim 1, further comprising a packet filtering unit deciding a lookup key, which is a key value corresponding to the security policy established in the first bank or the second bank, and discarding or transmitting the packet according to the security policy if the lookup key matches the discrimination key.

6. The apparatus of claim 1, further comprising a bandwidth controller deciding a lookup key, which is a key value corresponding to the security policy established in the first bank or the second bank, and controlling a bandwidth according to the security policy if the lookup key matches the discrimination key.

7. The apparatus of claim 1, wherein the lookup engine is a Ternary Contents Addressable Memory (TCAM).

8. A security method in a security apparatus for supporting Internet Protocol version 4 (IPv4) and IPv6, the method comprising:
classifying an IPv4 packet and an IPv6 packet based on version information in header information of an input IP packet;
generating header information corresponding to each of the classified IPv4 and IPv6 packets and generating a discrimination key corresponding to each of the classified IPv4 and IPv6 packets based on the generated header information; and
searching a lookup engine, which comprises a first bank in which a security policy for IPv4 packets is established and a second bank in which a security policy for IPv6 packets is established, as the first bank and the second bank using the discrimination key corresponding to each packet.

9. The method of claim 8, wherein the discrimination key corresponding to the IPv6 packet is generated using a hashing function.

10. The method of claim 9, wherein the second bank establishes the security policy using the hashing function.

11. The method of claim 8, wherein a different number of bits are assigned to each of the first bank and the second bank.

12. The method of claim 8, further comprising deciding a lookup key, which is a key value corresponding to the security policy established in the first bank or the second bank, and discarding or transmitting the packet according to the security policy if the lookup key matches the discrimination key.

13. The method of claim 8, further comprising deciding a lookup key, which is a key value corresponding to the security policy established in the first bank or the second bank, and controlling a bandwidth according to the security policy if the lookup key matches the discrimination key.

14. The method of claim 8, wherein the lookup engine is a Ternary Contents Addressable Memory (TCAM).
